(19) United States
(12) Patent Application Publication
(10) Pub. No.: US 2020/0383405 A1
(43) Pub. Date: Dec. 10, 2020

(54) Massage Gloves

(71) Applicant: TaeWeon Seok, Sungnam-Si (KR)

(72) Inventor: TaeWeon Seok, Sungnam-Si (KR)

(21) Appl. No.: 16/510,607

(22) Filed: Jul. 12, 2019

(30) Foreign Application Priority Data
Jun. 4, 2019 (KR) 10-2019-0065762

(51) Int. Cl. A41D 19/00; A61H 9/00; A61H 39/04; A61H 39/06

(52) U.S. Cl. CPC A41D 19/0024; A61H 9/0078; A61H 39/04; A61H 39/06; A61H 2201/1409; A41D 2400/322; A61H 2201/1635; A61H 2201/165; A61H 2205/067; A61H 2201/0207

(57) ABSTRACT

The present invention relates to a massage glove to promote hand health. More particularly, a massage glove is manufactured by welding of an upper panel and a lower panel, and finger insertion portions are divisionally formed in the upper panel and the lower panel, making it very convenient to manufacture cylindrical finger insertion portions. Also, the thumb insertion portion configured to be freely movable serves to put on the massage glove very easily, leading to uniform and tight wearing state for the entire massage glove and the entire hand, thereby providing convenience in putting on the glove and uniform massage effects in the massage operation. Further, the heating body embedded in the glove performs a thermal operation over the entire palm and fingers, further enhancing massage effects such as blood circulation improvement, etc.

### CROSS REFERENCE TO RELATED APPLICATION

The present application claims priority to Korean Patent Application No. 10-2019-0065762, filed Jun. 4, 2019, the entire content of which is incorporated herein for all purposes by reference.

### BACKGROUND OF THE INVENTION

### Field of the Invention

The present invention generally relates to a massage device to promote hand health. More particularly, the present invention relates to a massage glove having respective finger insertion portions in which structures of welded portions and finger insertion portions of the massage glove are improved, thereby increasing productivity and enabling a user to put on the glove more easily, and also taking a three-dimensional hand shape, serving to enable the glove to be worn in closer contact with a user's hand, which leads to further enhancing the massage effect.

### Description of the Related Art

Generally, massage is a type of oriental therapy to boost metabolism and improve functions of internal organs by stimulating acupuncture points distributed in the human body so as to smoothly control flow of energy and blood. By drawing the human body's natural healing power, effects such as to prevent or cure a variety of diseases are provided.

Also in our daily lives, as these effects could be obtained easily by massaging hands or feet by means of various massagers, it can be said that a massage is a very useful health remedy for modern people exposed to a variety of stresses that threaten health.

However, in order to perform acupressure treatment by use of a massager according to the related art, a user had to hold the massager with his/her hand for a long time. In this regard, the massager according to the related art has caused a problem such that the process was quite cumbersome and inconvenient. In addition, as massage on the entire hand could not be performed simultaneously, acupressure treatment was concentrated on some portions of the hand, and thus, it was difficult to obtain a uniform acupressure effect.

In order to solve this problem, a glove-type hand massager using air pressure was developed. As this hand massager according to the related art is shaped into a glove, a user can insert his/her hand into the glove. An air pocket into which air is injected is provided inside the glove, and air is injected into the air pocket so as to massage the user's hand through swelling and contraction of the air pocket.

However, the glove-type air pressure massager according to the related art is formed by partitioning air pockets in a finger portion to press the user's fingers and a hand portion to press the back and the palm of the user's hand into several sections, causing a problem that the massager is complex in structure and control.

As an alternative, a glove-type hand massager was conceived and registered under Korean Utility Model Registration No. 20-0296990. This glove-type hand massager includes an inner panel enclosing a user's hand, inside of which a plurality of acupressure bosses are provided, an outer panel provided outside an inner cover, and an air bag for injecting and exhausting air between the inner cover and an outer cover.

In addition, a hand massage device was conceived and registered under Korean Patent No. 10-1202813. The hand massage device is capable of performing massage for a user's hand by pressing acupuncture spots on the fingers, the palm, and the back of the user's hand by use of air pressure and heating the user's hand, and also activating the cell tissues of the hand by irradiating the hand with a low power laser light transmitted through an optical fabric, thereby stimulating regeneration of skin cells.

Subsequently, the inventor of the present invention conceived a hand massage machine using air pressure, which was patented under Korean Patent No. 10-1863848. This hand massage machine performs the massage function for the user's hand in such a manner of pressing the hand and relieving the pressure to the hand by supplying air pressure to or discharging the air pressure from an air pocket, simplifies the structure of the machine by forming the air pocket in an integral from so as to communicate with a finger pressing part and a hand pressing part, serving to facilitating the control thereof, and in particular, forms a separate auxiliary pressing part, being capable of easily performing a hand insertion process into the machine without interference and also preventing the pressure strength to the hand from being degraded, thereby increasing convenience in use and simultaneously maintaining the even pressure strength to the hand's entire region.

However, as the massage glove according to the related art enables massaging the hand only through air pressure, the massage is less effective in terms of blood circulation, etc., as compared to thermal massage. In addition, as the massage glove cannot exactly correspond to the user's hand or fingers, the massage effect on the entire hand including fingers is reduced.

Also, as edges of an upper panel and a lower panel for manufacturing a massage glove are simply welded to be manufactured in a plane shape, the glove cannot be worn so as to exactly correspond to the three-dimensional shape of the user's hand, thus the glove is not efficient.

That is, the thumb of the human hand is in an inclined shape as compared to remaining four fingers including the index finger, the middle finger, the ring finger, and the little finger that are arranged horizontally. However, the massage glove according to the related art was produced in a simple plane shape, without considering the three-dimensional shape of the human hand. In this regard, the wearability of the glove at the thumb portion was very poor, and the massage effect on the thumb and its periphery was degraded, thereby causing a problem that an even massage operation on the fingers and the entire hand could not be expected.

### Documents of Related Art

[Patent Documents]

(Patent Document 1) Korean Utility Model Registration No. 20-0296990 registered on Nov. 22, 2002

(Patent Document 2) Korean Patent No. 10-1202813 registered on Nov. 13, 2012

(Patent Document 3) Korean Patent No. 10-1863848 registered on May 28, 2018

### SUMMARY OF THE INVENTION

The present invention has been made keeping in mind the above problems occurring in the related art, and an object of the present invention is to provide a massage glove which is manufactured by welding an upper panel with a lower panel, each of which is a double-layered form and has an air passage thereon, wherein finger insertion portions formed in the massage glove are divisionally formed such that an index finger insertion portion and a ring finger insertion portion are only formed on the upper panel, a thumb insertion portion, a middle finger insertion portion, and a little finger insertion portion are only formed on the lower panel, and the thumb insertion portion formed on the lower panel is configured to be freely moveable irrelevantly to the upper panel, whereby the massage glove can provide uniform swelling of air pressure to the entire glove and each finger insertion portion, and very excellent convenience in putting on the glove due to the thumb insertion portion that is freely movable, and if necessary, a heating body may be fixedly formed inside the massage glove, that is, in the upper side of the lower panel, thereby enabling thermal massage operation.

In order to achieve the above object, according to one aspect of the present invention, there is provided a massage glove, including: an upper panel formed of a nonporous fabric sheet in a double-layered form and having a welding line formed thereon; and a lower panel formed of a nonporous fabric sheet in a double-layered form and having a welding line formed thereon, wherein: the upper panel includes a flat back portion of the hand, and a cylindrical index finer insertion portion, and a cylindrical ring finger insertion portion, which protrude from one side of the back portion, and the insides of the back portion, the index finger insertion portion, and the ring finger insertion portion are interconnected by an air passage; the lower panel includes a flat palm portion, and a cylindrical thumb insertion portion, a cylindrical middle finger insertion portion, and a cylindrical little finger insertion portion, which protrude from one side of the palm portion, and the insides of the palm portion, the thumb insertion portion, the middle finger insertion portion, and the little finger insertion portion are interconnected by an air passage; a lower side of the index finger insertion portion and a lower side of the ring finger insertion portion of the upper panel are respectively welded with an insertion protrusion protruding from the palm portion between the thumb insertion portion and the middle finger insertion portion of the lower panel, and another connection protrusion protruded from the palm portion between the middle finger insertion portion and the little finger insertion portion of the lower panel; the middle finger insertion portion and the little finger insertion portion of the lower panel are respectively welded with an insertion protrusion protruding from the back portion between the index finger insertion portion and the ring finger insertion portion of the upper panel, and another connection protrusion protruding from the back portion at one side of the ring finger insertion portion; and the air passage of the upper panel and the air passage of the lower panel are interconnected so as to allow the upper panel and the lower panel to be simultaneously swelled and contracted by air pressure supplied to either of the air passages.

According to the present invention, as finger insertion portions are divisionally formed in the upper panel and the lower panel, it is very convenient to manufacture cylindrical finger insertion portions. In addition, the operation to combine the upper panel with the lower panel each having divided finger insertion portions is very simple, providing very excellent productivity in manufacturing the massage glove. Also as the thumb insertion portion made so as to be freely movable serves to putting on the massage glove very easily, leading to uniform and tight wearing state for the entire massage glove and the entire hand, the massage glove of the present invention can obtain convenience in a state of wearing the glove and uniform massage effects in the course of massage. Further, the heating body embedded in the glove performs a thermal operation over the entire palm and fingers, further enhancing massage effects such as blood circulation improvement, etc.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing the entirety of a massage glove according to an exemplary embodiment of the present invention;

FIG. 2 is a plane view showing an upper panel of the massage glove according to an exemplary embodiment of the present invention;

FIG. 3 is a view showing a process of manufacturing finger insertion portions of the upper panel of the massage glove according to an exemplary embodiment of the present invention;

FIG. 4 is a plane view showing a lower panel of the massage glove according to an exemplary embodiment of the present invention;

FIG. 5 is a view showing a process of manufacturing finger insertion portions of the lower panel of the massage glove according to an exemplary embodiment of the present invention;

FIG. 6 is a perspective view showing the entirety of a heating body of the massage glove according to an exemplary embodiment of the present invention;

FIG. 7 is a view showing interconnection of the upper panel and the lower panel of the massage glove according to an exemplary embodiment of the present invention;

FIG. 8 is an exploded view showing air connection of the upper panel and the lower panel of the massage glove according to an exemplary embodiment of the present invention; and

FIG. 9 is a view showing insertion of the heading body into the massage glove according to an exemplary embodiment of the present invention.

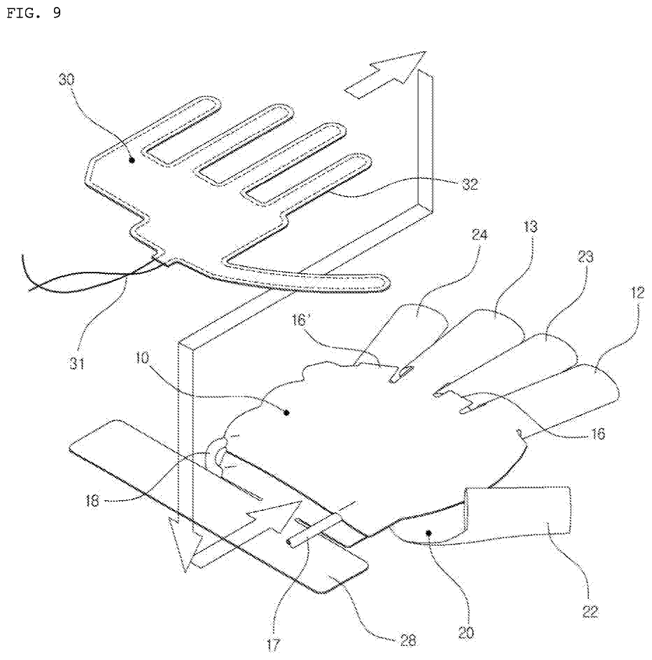

### DETAILED DESCRIPTION OF THE INVENTION

With respect to the present invention, various modifications are possible, thus the present invention could have various embodiments. In this regard, it should be appreciated that exemplary embodiments of the present invention described below and illustrated in the drawings are not to any specific embodiments of the present invention, and they would cover all changes, equivalents, and substituents included in the concept and the technical scope of the present invention.

Hereinbelow, exemplary embodiments of the present invention will be described in detail with reference to the accompanying drawings.

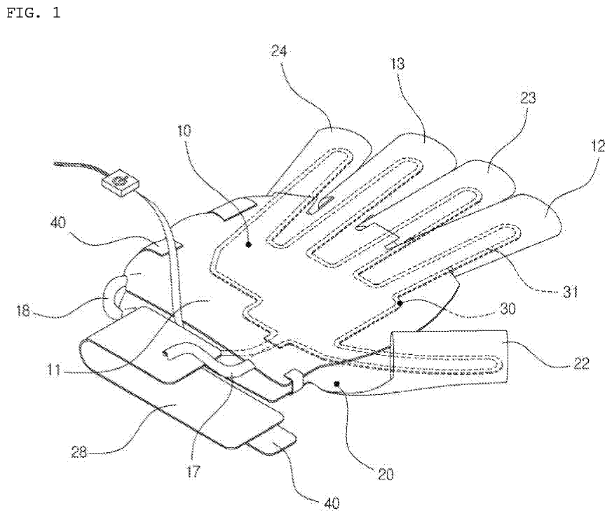

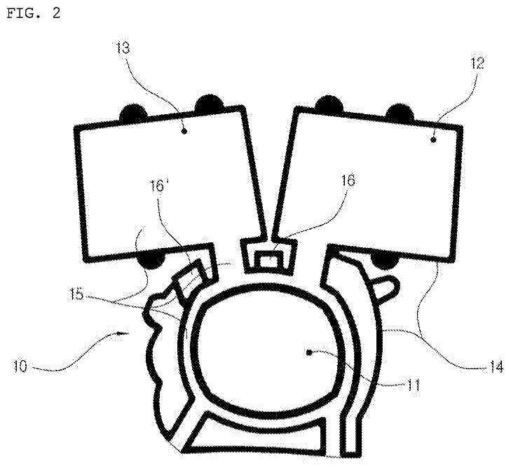

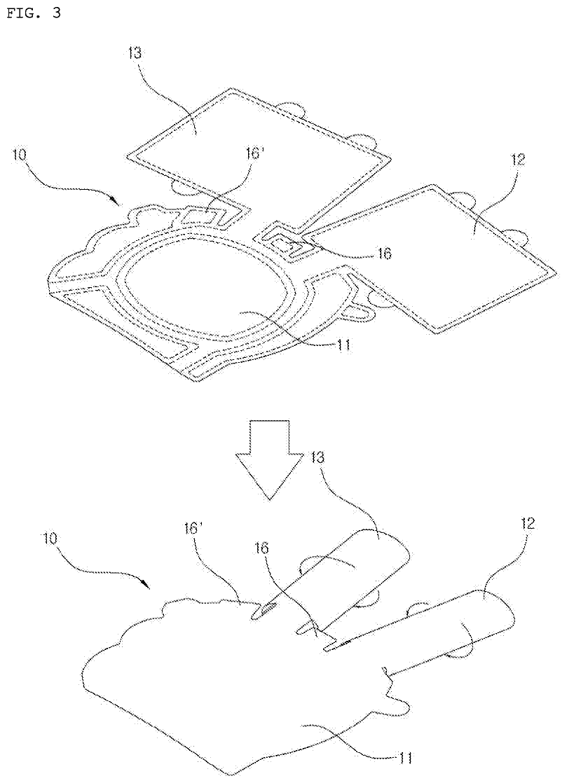

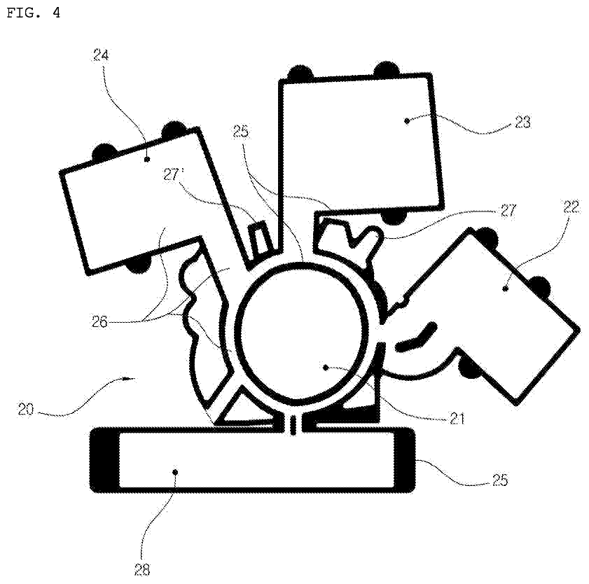

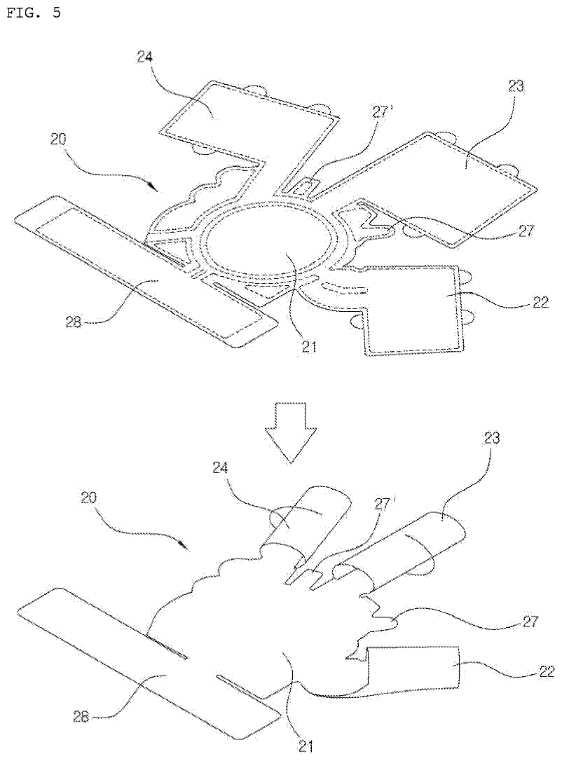

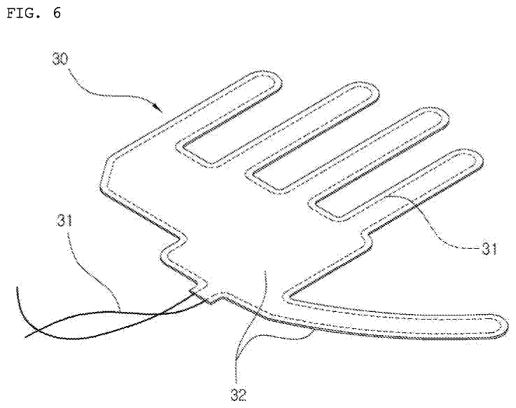

FIG. 1 is a perspective view showing the entirety of a massage glove according to an exemplary embodiment of the present invention, FIG. 2 is a plane view showing an upper panel of the massage glove according to an exemplary embodiment of the present invention, FIG. 3 is a view showing a process of manufacturing finger insertion portions of the upper panel of the massage glove according to an exemplary embodiment of the present invention, FIG. 4 is a plane view showing a lower panel of the massage glove according to an exemplary embodiment of the present invention, FIG. 5 is a view showing a process of manufacturing finger insertion portions of the lower panel of the massage glove according to an exemplary embodiment of the present invention, and FIG. 6 is a perspective view showing the entirety of a heating body of the massage glove according to an exemplary embodiment of the present invention.

As shown in the drawings, a massage glove according to the present invention is manufactured by welding an upper panel 10 with a lower panel 20, which are made a nonpermeable (airproof) fabric sheet. Each of the upper panel 10 and the lower panel 20 is made by overlapping the airproof fabric sheet in two layers, to make a double-layered panel by thermal compression. The upper panel and the lower panel made as described above are combined together and cut so as to manufacture a massage glove according to the present invention.

At this time, it is preferable to use a nylon sheet, to which a polyurethane (PU) film is attached thereon, as an airproof sheet. In a state that two nylon sheets are placed so that the PU films face each other, if the nylon sheets are thermally compressed at high temperature, the pressed portions of the PU films are melted according to the shape of a welding mold, and combination of the upper fabric sheet with the lower fabric sheet are conducted through a welding line. After or during the thermal compression, the upper panel 10 and the lower panel 20 are manufactured in the shapes as desired by passing through a cutting process according to the designed shapes of the upper panel 10 and the lower panel 20.

The upper panel 10 as described above includes a flat back portion 11 of the hand in the generally same shape as the back of a human hand, and an index insertion portion 12 and a ring finger insertion portion 13 in a circular shape, which protrude from one side of the back portion 11, and is formed of a double-layered sheet having a welding line 14 in the edges of all the back portion 11, the index finger insertion portion 12 and the ring finger insertion portion 13.

That is, in order to manufacture the upper panel 10 as described above, in a state that two fabric sheets overlap, they are thermally welded together and then cut along the welding line 14 so as to form the back portion 11, the index finger insertion portion 12, and the ring finger insertion portion 13 thereof. The insides of the back portion 11, the index finger insertion portion 12, and the ring finger insertion portion 13 not welded are interconnected so as to constitute an air passage 15 due to the double-layered form and the welding line 14.

Also, a connection protrusion 16 is formed in a protruding manner, being extended from one side of the back portion 11 between the index finger insertion portion 12 and the ring finger insertion portion 13 as described above, and another connection protrusion 16′ is formed in a protruding manner extending from the back portion 11 corresponding to one side of the ring finger insertion portion 13.

As shown in FIG. 3, in a state that the upper panel 10 is compressed and cut as described above, both lateral ends of a flat finger insertion portion are rolled to make a rounded form and a welding operation is again applied to both lateral ends thereof overlapping with each other. Through this operation, a cylindrical index finger insertion portion 12, and a cylindrical ring finger insertion portion 13 with respect to the flat back portion 11 may be formed.

At this time, the cylindrical index finger insertion portion 12 and the cylindrical ring finger insertion portion 13 should be formed so as to protrude downwardly from the surface of the back portion 11. If both lateral ends of the finger insertion portion made flat by welding and cutting processes are rolled downwardly and then welded together, the cylindrical index finger insertion portion 12 and the cylindrical ring finger insertion portion 13 have a protruded form downwardly from the surface of the back portion 11.

Subsequently, the lower panel 20 as described above includes the flat palm portion 21 having the shape of the human's palm, and the thumb insertion portion 22, the middle finger insertion portion 23, and the little finger insertion portion 24, which protrude from one end of the palm portion 21, also through a cutting process along a welding line 25 due to thermal compression in a state that the fabric sheets overlap in a double-layered from.

Also, the insides of the thumb insertion portion 22, the middle finger insertion portion 23 and the little finger insertion portion 24 are interconnected by an air passage 26. A connection protrusion 27 between the thumb insertion portion 22 and the middle finger insertion portion 23 protrudes from the palm portion 21 at a position corresponding to the index finger insertion portion 12 of the upper panel 10, and another connection protrusion 27′ between the index insertion portion 23 and the little finger insertion portion 24 protrudes from the palm portion 21 at a position corresponding to the ring finger insertion portion 13 of the upper panel 10.

A wrist band 28 integrally combined with the palm portion 21 is formed in an elongated manner on a lower side of the palm portion 21. The inside of the wrist band 28 is also connected to the air passage 26 as described above. Accordingly, the entire insides of the palm portion 21, the thumb insertion portion 22, the middle finger insertion portion 23, the little finger insertion portion 24, and the wrist band have a structure to communicate with each other through the air passage 26.

In the lower panel 20 as described above, the thumb insertion portion 22, the middle finger insertion portion 23, and the little finger insertion portion 24 are rolled and welded so as to be in a cylindrical form, as shown in FIG. 5. Both lateral ends of the thumb insertion portion 22, the middle finger insertion portion 23, and the little finger insertion portion 24 are rolled upwardly to overlap with each other, and both lateral ends which are overlapping are thermally welded together and fixed to each other, thereby making cylindrical finger insertion portions. The thumb insertion portion 22, the middle finger insertion portion 23, and the little finger insertion portion 24 should be manufactured to have a cylindrical form by rolling them upwardly from the flat palm portion 21.

As shown in FIG. 6, a heating body 30 used for the massage glove of the present invention includes a heating wire 31 arranged in the shape of fingers and a cover material 32 having a hand shape and functioning as a sheath of the heating wire 31. As the heating body 30 is fixedly inserted into the inside of the massage glove, thereby providing heat to the user's hand as well as to the massage glove, a massage effect such as blood circulation improvement is improved due to the heating operation.

The upper panel 10, the lower panel 20, and the heating body 30 constructed as described above form a final massage glove through welding of the upper panel 10 with the lower panel 20, and insertion and fixation of the heating body 30.

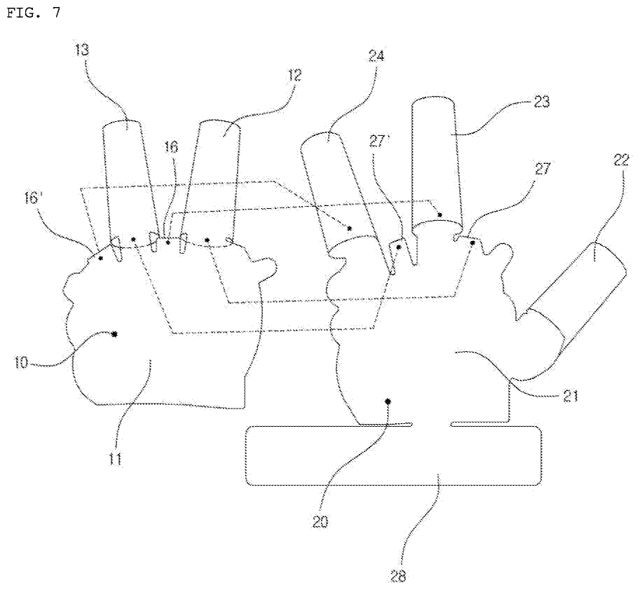

That is, the upper panel 10 and the lower panel 20 are arranged to face each other and to be isolated from each other. In this state, a lower side of the index finger insertion portion 12 of the upper panel 10 overlaps with the connection protrusion 27 protruding between the thumb insertion portion 22 and the middle finger insertion portion 23 of the lower panel 20, as shown in FIG. 7, and the overlapping portions are welded together and fixed. Also, a lower side of the ring finger insertion portion 13 of the upper panel 10 overlaps with another connection protrusion 27′ protruding between the middle finger insertion portion 23 and the little finger insertion portion 24 of the lower panel 20, and the overlapping portions are welded together and fixed.

Subsequently, an upper side of the middle finger insertion portion of the lower panel 20 overlaps with the connection protrusion 16 protruding between the index finger insertion portion 12 and the ring finger insertion portion 13 of the upper panel 10 and are then welded together as overlapping in a fixedly manner. An upper side of the little finger insertion portion 24 of the lower panel 20 overlaps with another connection protrusion 16′ protruding from a lateral side of the ring finger insertion portion 13 of the upper panel 10, and they are welded together as overlapping and fixed to each other, whereby the index finger insertion portion 12 and the ring finger insertion portion 13 of the upper panel 10 are fixed to the connection protrusions 27 and 27′ of the lower panel 20, respectively, and the middle finger insertion portion 23 and the little finger insertion portion 24 of the lower panel 20 are firmly connected and fixed to the connection protrusions 16 and 16′ of the upper panel 10, respectively.

At this time, the thumb insertion portion 22 of the lower panel 20 is neither additionally connected nor fixed to the upper panel 10, thereby allowing the cylindrical thumb insertion portion 22 to move freely from one side of the lower panel 20.

Accordingly, the upper panel 10 and the lower panel 20 manufactured through the welding process as described above are disposed to face each other and isolated from each other. At the same time, the index finger insertion portion 12, the middle finger insertion portion 23, the ring finger insertion portion 13, and the little finger insertion portion 24 are sequentially positioned at each one side of the upper panel 10 and the lower panel 20, so that the thumb insertion portion 22 maintains its combination state to be freely movable from one side of the lower panel 20.

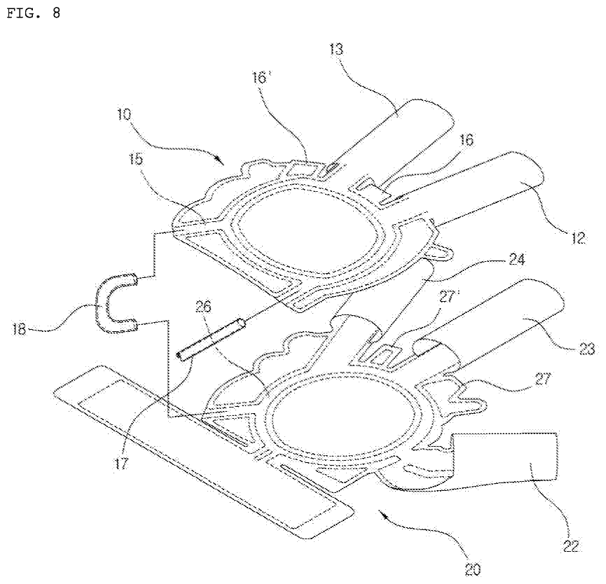

After passing through the welding process as described above, the air passage 15 of the upper panel 10 and the air passage 26 of the lower panel 20 are interconnected through an air connection tube 18 as shown in FIG. 8. An end of the air connection tube 18 is inserted into the air passage 15 from the end of the back portion 11, allowing the air connection tube 18 and the back portion 11 to be fixedly welded together, and the other end of the air connection tube 18 is inserted into the air passage 26 from the end of the palm portion 21 of the lower panel 20, allowing the air connection tube 18 and the palm portion 21 to be fixedly welded together, to thereby allow the air passage 15 of the upper panel 10 and the air passage 26 of the lower panel 20 to be interconnected to each other.

In this state, an air injection tube 17 inserted into the air passage 15 from the end of the back portion 11 of the upper panel 10 is fixedly welded, thereby completing manufacture of the massage glove according to the present invention. If air is injected into the air passage 15 of the upper panel 10 through the air injection tube 17, the back portion 11, the index finger insertion portion 12, and the middle finger insertion portion 13 of the upper panel 10 start to be swelled by the injected air. At the same time, if air is injected into the air passage 26 of the lower panel 20 through an air connection tube 18, the palm potion 21, the thumb insertion portion 22, the middle finger insertion portion 23, and the little finger insertion portion 24 of the lower panel 20 are simultaneously swelled by the injected air.

At this time, in order to put on the massage glove, a user inserts his/her hand between the back portion 11 and the palm portion 21 to thereby allow each finger of his/her hand to be inserted into each finger insertion portion. As the user's thumb is inserted into the thumb insertion portion 22 of the lower panel 20, the user's thumb is relatively freely movable, thereby enabling the massage glove to be more conveniently worn.

In particular, a fastening means 40 is formed on the back portion 11 of the upper panel 10 and the palm portion 21 of the lower panel 20 respectively, so as to couple the back portion 11 and the palm portion 21. The back portion 11 and the palm portion 21 in an isolated state from each other can be fixed to come into close contact with the user's hand by the fastening means 40, thereby enabling more excellent wearability and synergetic massage effects. The fastening means 40 may be realized in various forms such as a Velcro tape, a button, a snap button, or a clip, etc.

Also, after the user's hand is inserted between the upper panel 10 and the lower panel 20, the wrist band 28 having an extended form that is extended from the lower panel 20 is wrapped around the user's wrist and is then fixed by use of the fastening means 40 provided at opposite ends of the wrist band 28. In this state, by repeating the processes to inflate and deflate the massage glove, a message operation on the user's entire hand and wrist may be performed. As necessary, an air passage 26 may not be formed in the wrist band 28 so as to prevent air from being injected thereonto. In this case, the wrist band 28 may function to simply maintain the stable wearing state of the massage glove.

In this state, as the processes to inflate and deflate the upper panel 10 and the lower panel 20 through the air connection tube 18 are repeated, the upper panel 10 and the lower panel 20 simultaneously repeat swelling and contraction operations, thereby obtaining massaging effects on the back, palm, and fingers of the user's hand.

In order to improve operations and effects of the massage glove according to the present invention, the heating body 30 is inserted into the massage glove as shown in FIG. 8. The inner temperature of the glove and the temperature of the skin increase according to application of power to the heating body 30, which serves to stimulate blood circulation.

At this time, the heating body 30 is configured so as to allow the heating wire 31 in the shape of fingers to be inserted into each finger insertion portion and thereafter allow the cover material 32 enclosing the heating wire 31 to be locally welded with and fixed to the lower panel 20. Accordingly, the heating body 30 is maintained in close contact with the upper surface of the lower panel 20.

If necessary, the user can use the massage glove by applying power to the heating body 30, or otherwise use the massage glove without applying power to the heating body 30.

In the massage glove of the present invention as described above, the thumb insertion portion 22 not connected to the upper panel 10 allows the user to insert his/her thumb into the glove easily without inconvenience and at the same time to freely move his/her thumb, thereby providing very excellent convenience in use. In addition, the upper panel 10 and the lower panel 20 are separately manufactured, and each finger insertion portion is also intermittently divisionally formed on the upper panel 10 or the lower panel 20, thereby enabling the glove to be manufactured so as to be adapted to the actual user's hand and finger positions, which is different from the shapes of the gloves according to the related art that have each finger insertion portion at artificial intervals. Accordingly, the massage glove of the present invention is capable of providing superior wearability and excellent massage effects.

The embodiments described in the specification and the configurations shown in the drawings are merely to an exemplary embodiment of the present invention most preferable, and they do not represent the entire technical concept of the present invention. In this regard, it should be appreciated that various equivalents and modifications, etc. are possible, without departing from the scope and spirit of the invention as disclosed in the accompanying claims.

What is claimed is:

1. A massage glove, comprising:
an upper panel (10) formed of a nonporous fabric sheet in a double-layered form, having a welding line (14) formed thereon; and
a lower panel (20) formed of a nonporous fabric sheet in a double-layered form, having a welding line (25) formed thereon,
wherein the upper panel (10) includes a flat back portion (11) of the hand, and a cylindrical index finer insertion portion (12) and a cylindrical ring finger insertion portion (13), which protrude from one side of the back portion (11), and the insides of the back portion (11), the index finger insertion portion (12), and the ring finger insertion portion (13) are interconnected by an air passage (15),
the lower panel (20) includes a flat palm portion (21), and a cylindrical thumb insertion portion (22), a cylindrical middle finger insertion portion (23), and a cylindrical little finger insertion portion (24), which protrude from one side of the palm portion (21), and the insides of the palm portion (21), the thumb insertion portion (22), the middle finger insertion portion (23), and the little finger insertion portion (24) are interconnected by an air passage (26),
a lower side of the index finger insertion portion (12) and a lower side of the ring finger insertion portion (13) of the upper panel (10) are respectively welded with an insertion protrusion (27) protruding from the palm portion (21) between the thumb insertion portion (22) and the middle finger insertion portion (23) of the lower panel (10), and another connection protrusion (27′) protruding from the palm portion (21) between the middle finger insertion portion (23) and the little finger insertion portion (24) of the lower panel (10),
the middle finger insertion portion (23) and the little finger insertion portion (24) of the lower panel (20) are respectively welded with an insertion protrusion (16) protruding from the back portion (11) between the index finger insertion portion (12) and the ring finger insertion portion (13) of the upper panel (10), and another connection protrusion (16′) protruding from the back portion (11) at one side of the ring finger insertion portion (13), and
the air passage (15) of the upper panel (10) and the air passage (26) of the lower panel (20) are interconnected so as to allow the upper panel (10) and the lower panel (20) to be simultaneously swelled and contracted by air pressure supplied to either of the air passages (15, 26).

2. The massage glove of claim 1, wherein an air injection tube (17) separately provided is welded with and fixed to the air passage (15) located at the back portion (11) of the upper panel (10), and the air passage (15) of the upper panel (10) and the air passage (26) of the lower panel (20) are configured to be interconnected by an air injection tube (18) separately provided, thereby allowing the upper panel (10) and the lower panel (20) to be simultaneously swelled and contracted according to air pressure supplied through the air injection tube (17).

3. The massage glove of claim 1, wherein a wrist band (28) in a double-layered form is formed in an extended form that is extended from one side of the palm portion (21) of the lower panel (20), and the inside of the wrist band (28) is connected to the air passage (26), thereby allowing the wrist band (28) to be swelled and contracted together with the upper panel (20).

4. The massage glove of claim 1, wherein a heating body (30) separately provided is inserted between the upper panel (10) and the lower panel (20), the heating body (30) being configured to be welded with and fixed to an upper surface of the lower panel (20).

5. The massage glove of claim 4, wherein the heating body (30) includes a heating wire (31) arranged in a finger shape so as to be inserted into each finger insertion portion of the upper panel (10) and the lower panel (20), and a cover material (32) having a hand shape and functioning as a sheath of the heating wire (31).

6. The massage glove of claim 1, wherein the back portion (11) of the upper panel (10), the palm portion (21) of the lower panel (20), and opposite ends of a wrist band (28) of the lower panel (20) are configured to be connected to each other or disconnected from each other by a fastening means (40).
